(19) United States
(12) Patent Application Publication
(10) Pub. No.: US 2018/0343904 A1
(43) Pub. Date: Dec. 6, 2018

(54) CABLED BIN FOR A CIDER PRESS

(71) Applicant: Brian W. Nelson, Puyallup, WA (US)

(72) Inventor: Brian W. Nelson, Puyallup, WA (US)

(21) Appl. No.: 15/615,781

(22) Filed: Jun. 6, 2017

(51) Int. Cl. A23L 19/00; B30B 9/02

(52) U.S. Cl. CPC A23L 19/09; A23N 1/00; A23L 19/00; B30B 9/02

(57) ABSTRACT

A bin for containing an apple mash within a cider press, the bin including a multiple of staves interconnected and held together by a cable threaded through each stave. Preferably, an upper cable and a lower cable hold the staves together, with each cable received into a first terminal stave and threaded through a multiple of staves in sequence, to a second terminal stave. The cabled bin resists bending, to maintain tension and to form a full circle when bent, while rebounding flat when released. To secure the bin in the curved, cylindrical or tubular form, the bin includes a bin latch to lock the first terminal stave to the second terminal stave. When the bin is not in use in the cider press, it can be stored and easily cleaned by lying-out flat, requiring much less storage space compared to traditional bins in fruit presses.

### FIELD OF INVENTION

The present invention relates to a bin for a juice press, and more specifically an improved type of staved bin, for containing an apple mash within a cider press.

### BACKGROUND

A mechanical press can be employed to squeeze a juice product from a fruit that is ground or mashed before pressing. When the fruit processed by the mechanical press is apples, the press may be referred to as a “cider press,” and the juice product referred to as apple cider, or simply “cider.” A traditional cider press is a ram type of press, with apples first ground up into a mash, and placed into a basket within the cider press.

Conventionally, the basket employed in a cider press is a slatted and open bottomed “bin,” having a cylindrical shape and made of staves, with each stave screwed or riveted to a set of hoops, surrounding the bin. A ram or piston is then used to exert pressure on pre-ground apple mash or pulp within the bin, pressing on the pulp from the top opening in the bin, squeezing the cider from the remaining, spent solids or “pomace.” There is an increased demand for small and portable cider presses, with the increase in at home or “craft” cider makers. The conventional cider press bin is difficult to clean and store, in that the conventional bin is fixed in size and shape, and the slats of the bin do not lend themselves to cleaning or scrubbing. An improved bin is needed that is easier to clean and takes up less room in storage, which would be especially suited to and desirable by home-made cider producers.

### BRIEF DESCRIPTION OF DRAWINGS

FIG. 1 is an isometric view of a cider press with a bin, according to a preferred embodiment of the present invention;

FIG. 2 is an isometric view of a bin for a cider press in a flattened position, according to a preferred embodiment of the present invention;

FIG. 3 is an isometric view of a bin for a cider press in a flattened position, according to a preferred embodiment of the present invention;

FIG. 4 is an isometric view of a bin for a cider press in a tubular formation, according to a preferred embodiment of the present invention;

FIG. 5 is an end view of a bin for a cider press in a tubular formation, according to a preferred embodiment of the present invention;

FIG. 6 is an isometric view of a stave for a bin, according to a preferred embodiment of the present invention; and

FIG. 7 is an isometric view of a stave for a bin, according to a preferred embodiment of the present invention.

### DETAILED DESCRIPTION OF PREFERRED EMBODIMENTS

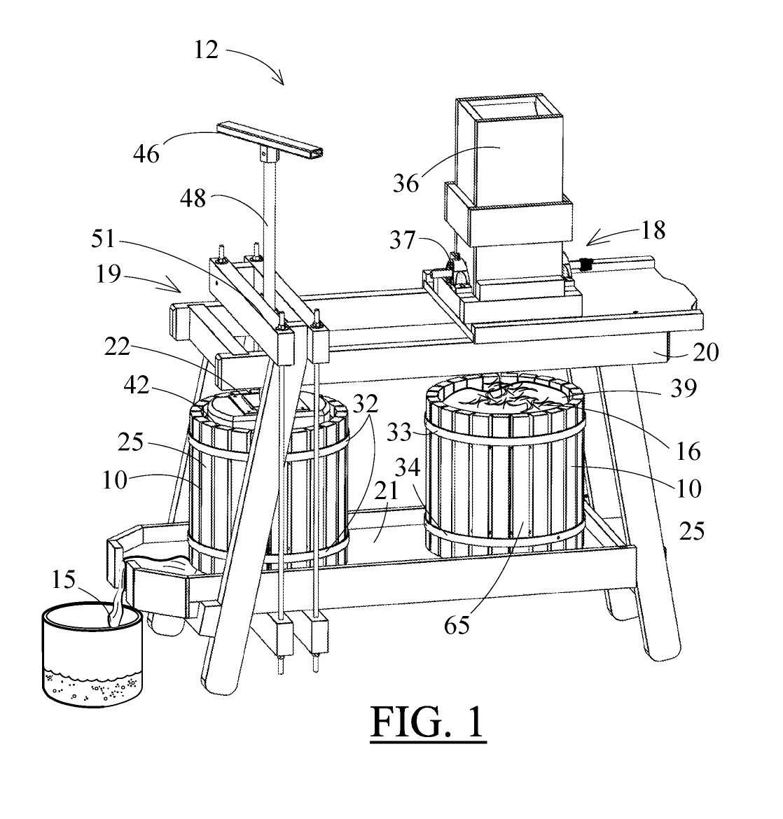

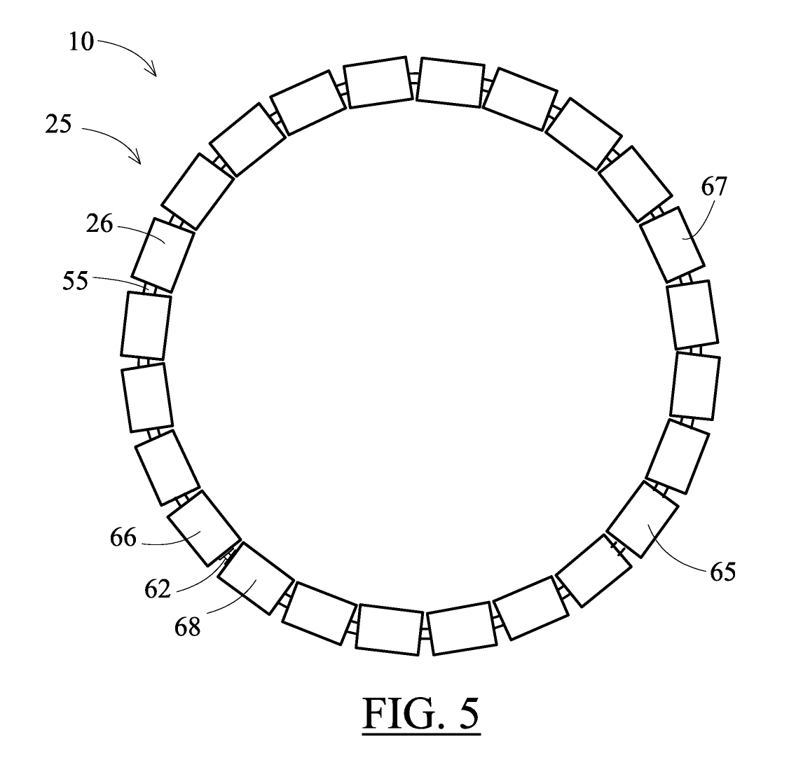

The present invention provides an improved bin for a juice or a cider press. In a conventional cider press, a bin is used to contain and confine an apple mash for the pressing process. Typically, the bin includes a slatted basket or “bin.” FIGS. 1 through 7 show an improved bin 10 for a cider press 12, according to a preferred embodiment of the present invention. When apples are the fruit processed by a mechanical fruit press, the press may be referred to as a “cider press,” and the juice product may be referred to as an apple cider, or simply “cider.” Again, the mechanical press is employed to squeeze a juice product from a fruit mash, and the cider press a specific type of a mechanical press employed to squeeze a cider from a fruit mash comprising apples. Generally, the operation of the cider press includes two primary steps; a pulverizing or a grinding the apples into a mash 16, followed by a pressing or squeezing of the mash, to extract a cider 15 from the mash and leave the spent apple solids or a “pomace” within the bin of the cider press. The pulverizing or grinding portion of the cider press can be referred to as a “mill stage” 18, and the pressing or squeezing portion of the cider press can be referred to as a “press stage” 19.

Preferably, both the mill stage 18 and the press stage 19 of the cider press 12 are built into a press frame 20. As shown in FIG. 1, the mill stage and the press stage share a cider tray 21 in common, with the cider tray held within the press frame and position-able and movable beneath either the mill stage or the press stage. The bin 10 sits in and is supported by the cider tray, and can slide within the cider tray. The bin can be re-positioned below the mill stage or the press stage, or lifted and completely removed from the cider tray, as needed. The bin is open at its top and bottom, with a multiple of staves 25, in the general form of a basket, and having a generally cylindrical shape. Each of the multiple of staves is a stave 26, and typically each stave is made of wood. Alternatively, the multiple of staves could be a plastic material, a metal, or a plastic coated wood or metal. Most preferably, each stave has an approximately square shaped cross-section.

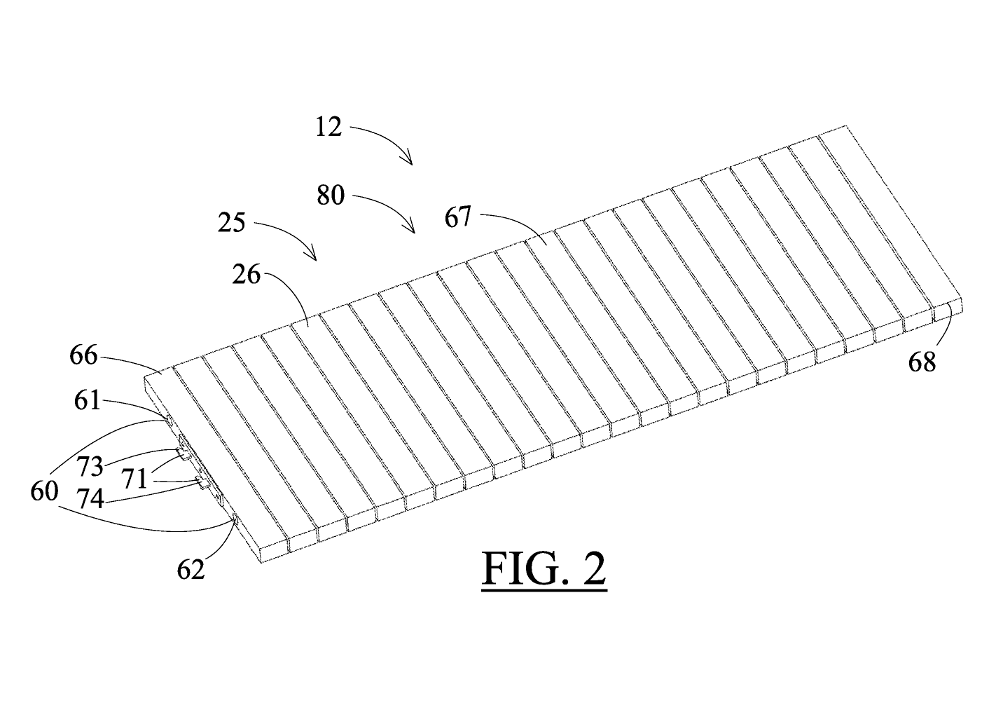

As shown in FIG. 2, the cylindrical bin 10 has a top opening 28 and a bottom opening 29, with a pair of bin hoops 32, as shown in FIG. 1. The pair of bin hoops confine the multiple of staves 25 and maintain the shape of the bin as a tube or cylinder. A top hoop 33 is positioned proximate to the top opening, and a bottom hoop 34 is positioned proximate to the bottom opening. When used in the cider press 12, the mash 16 is held within the bin by the cider tray 21 directly beneath the bottom opening of the bin, as shown in FIG. 1.

The mill stage 18 of the cider press 12 initially pulverizes or grinds the apples into the mash 16, prior to pressing. As shown in FIG. 1, the mill stage preferably includes a hopper 36 above an enclosed grinding drum 37, or an equivalent device with a purpose to pulverize the apples into the mash. The apples are fed into the hopper and pass through the grinding drum to be mashed. Preferably, the mash generated by the mill falls into the bin 10, as positioned on the cider tray 21 below the mill stage.

The bin 10 of the cider press 12 is filled with the mash 16, and the mash is wrapped most preferably with a bin cloth 39 or bag, which is set within the bin, as shown in FIG. 1. The bin cloth prevents the spent pomace from leaking out of the bin between the multiple of staves 25, and the bin cloth also acts as an initial filter for the cider 15 squeezed from the mash. For pressing the mash, the bin is slid on the cider tray 21 from beneath the mill stage 18 to beneath the press stage 19, and there the bin is positioned beneath a piston 42. As shown in FIG. 1, the press stage of the cider press preferably employs the piston to squeeze the apple mash within the bin. The piston of the press stage can be referred to as a “ram,” and can be any mechanical device for exerting pressure on the mash contained within the bin.

In a preferred, manually operated embodiment of the cider press 12, the piston 42 includes a press handle 46 connected to a press plate 47 by a screw shaft 48. The screw shaft has a shaft thread 49. The shaft thread is received into and engages with a press thread 51 in the press frame 20. With the press plate sized and shaped to match and fit within the top opening 28 of the bin 10, and with the press plate positioned at the top opening of the bin, a turning or cranking of the press handle serves to rotate the screw shaft. With the threaded engagement of the shaft thread with the press thread, the press plate of the piston advances into the top opening in the bin and presses on the mash 16 wrapped with the bin cloth 39 and contained within the bin. The action of the piston squeezes the cider 15 out of the mash, rendering the juice of the apples as cider, from the pomace. Again, the pomace is mostly spent apple solids, and includes the skin, seeds, stems, and fleshy pulp of the processed apple. In the press stage 19 the cider is separated from the pomace, and the cider drains from the bin through the bin cloth and between the multiple of staves 25 onto the cider tray 21 for collection. Typically, the cider press recovers approximately 50% to 65% of the liquid cider present in the apples, which are approximately 85% liquid, by weight.

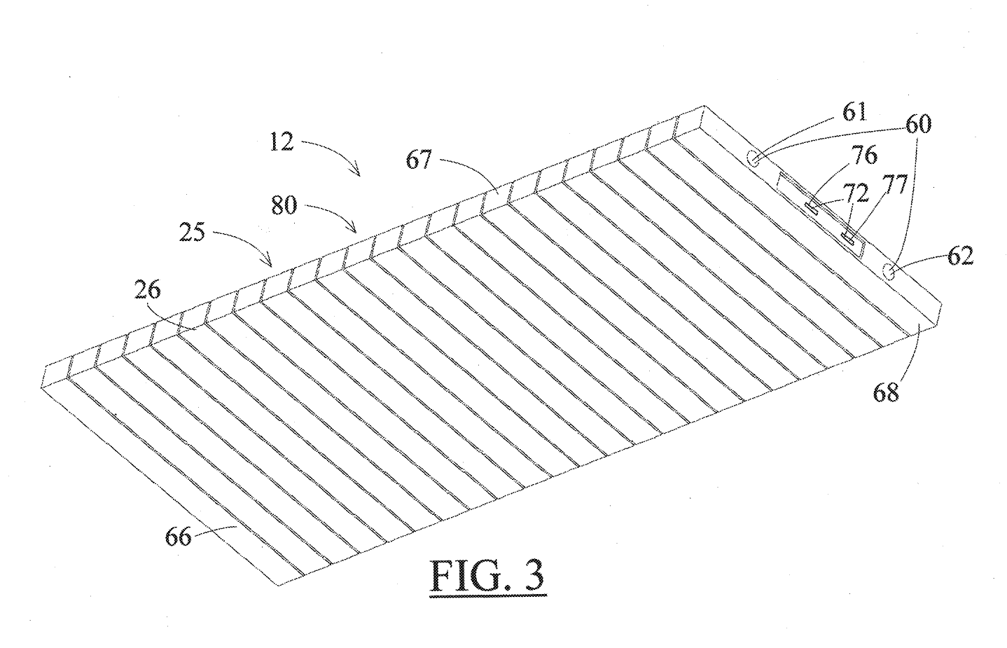

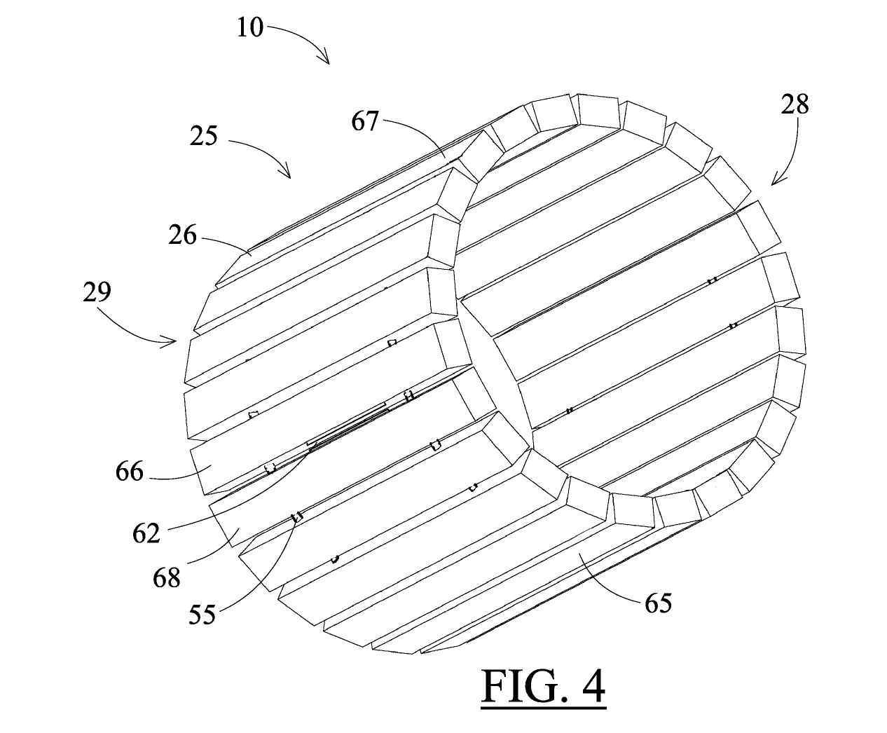

For a preferred embodiment of the present invention, the bin 10 is held together by a cable 55 that runs through each stave 26, interconnecting the staves as shown in FIG. 4. Preferably two cables, namely an upper cable 56 and a lower cable 57 are used to interconnect and hold the multiple of staves 25 together. As shown in FIGS. 2, 3, 6, and 7, each stave includes a cable eye 60, and most preferably two cable eyes, namely an upper eye 61 and a lower eye 62. Each cable is received into a first terminal stave 66, and threads through a multiple of middle staves 67 in sequence, to a second terminal stave 68. Again, as preferred with two cables, the upper cable attaches at and threads through the upper eye of the first terminal stave, and the lower cable attaches at and threads through the lower eye of the first terminal stave. After the first terminal stave, the upper cable then threads through the upper eye of each stave of the multiple of middle staves and then attaches to the second terminal stave at its upper eye, as detailed in FIGS. 2 and 3. Likewise, after the first terminal stave, the lower cable threads through the lower eye of each stave of the multiple of middle staves and then attaches to the second terminal stave at its lower eye.

Preferably, the cable 55 for use in connecting the multiple of staves 25 in the bin 10 are made from a stainless steel. Most preferably, the cable includes twisted strands of stainless steel with a circular cross-section, but alternatively could be braided with a flat or oval cross section. The preferred cable resists bending, to maintain tension and form a full circle when bent, while rebounding flat when released. As shown in FIGS. 3 and 4, the cable maintains a separation of the multiple of staves, keeping them ‘picketed,’ in parallel to each other, while allowing for the cable between each stave 26 to be bent or curved, so that the staves can form the preferred cylindrical shape the bin requires.

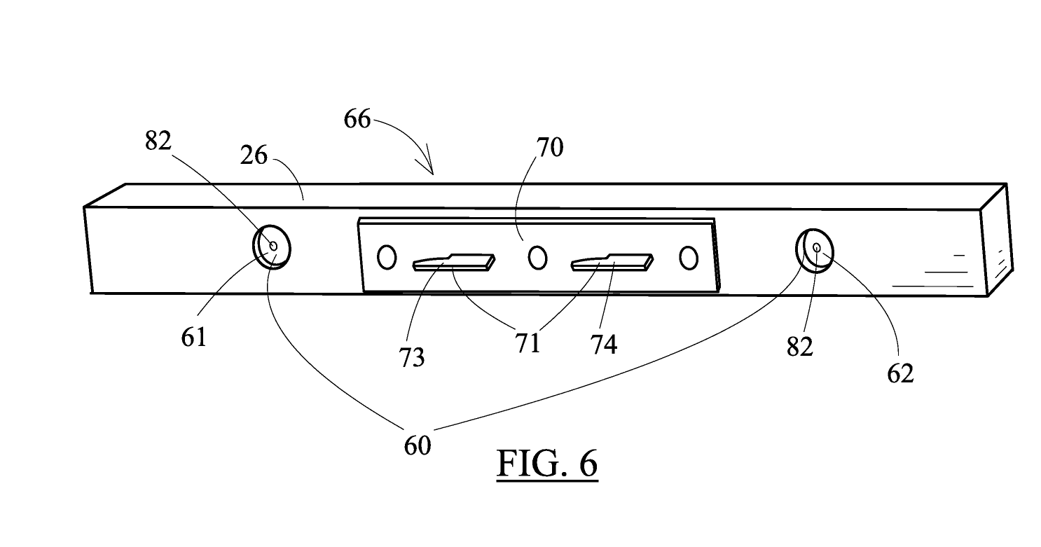

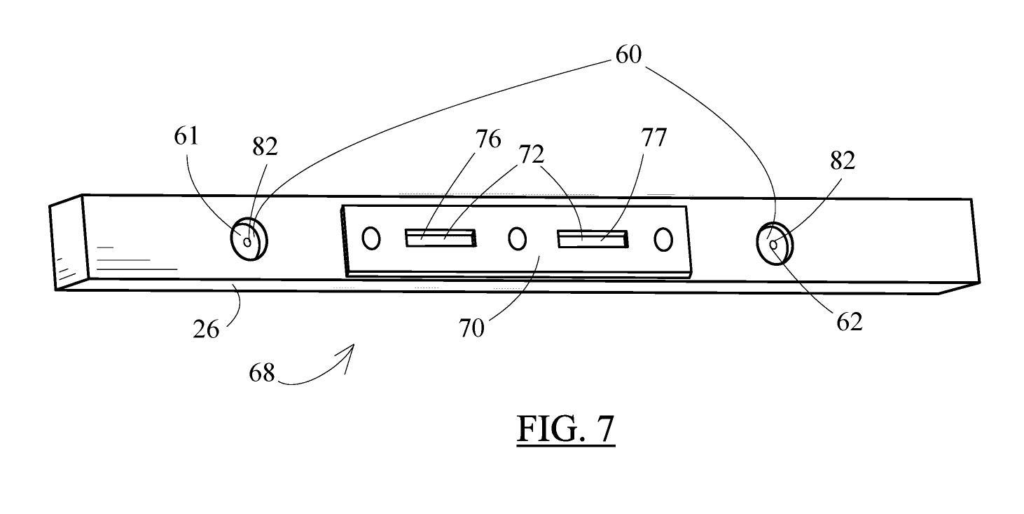

When used in the cider press 12, the multiple of staves 25 of the bin 10 are positioned along a curve, in a tubular formation 65 as shown in FIGS. 3 and 4, so that the first terminal stave 66 is brought about in a circle to contact the second terminal stave 68. To secure the bin in the curved, cylinder in the tubular form, the bin includes a bin latch 70 to lock the first terminal stave to the second terminal stave. The bin latch is a ‘male and female’ attachment that serves to connect the first terminal stave to the second terminal stave of the bin. As shown in FIG. 6, the first terminal stave can include a set of stave hooks 71, which are received by and lock into a set of stave slots 72 in the second terminal stave shown in FIG. 7. As an alternative, this configuration can be switched, with the set of stave hooks in the second terminal stave and the set of stave slots in the first terminal stave. Preferably, as detailed in FIG. 6, the set of stave hooks include an upper hook 73 and a lower hook 74. Likewise, the set of stave slots include an upper slot 76 that receives the upper hook, and a lower slot 77 that receives the lower hook, as detailed in FIG. 7. Alternatively, any number of mated hooks and slots could be used to connect the first terminal stave to the second terminal stave of the bin.

When the bin 10 is not in use in the cider press 12 in the tubular formation 65, the bin can be stored by laying-out flat in a flattened position 80, as shown in FIGS. 2 and 3. With the preferred inherent rebound or tension of the cable 55, the cable tension wants to relax the bin to the flattened position, which is straight and resistant to bending. So, with the constant cable force to straighten or flatten the multiple of staves 25, the bin holds the shape of a circle when the first terminal stave 66 contacts with and connects to the second terminal stave 68. When the bin latch 70 is opened, with the set of stave hooks 71 released from the set of stave slots 72, the multiple of staves readily uncurl and lie flat, in the flattened position.

In the flattened position 80, the preferred bin 10 is approximately 37 inches in length from the first terminal stave 66 to the second terminal stave 68, with each stave 26 approximately 14 inches in length and approximately 1 inch in thickness, and with each of the multiple of staves 25 separated with the cable 55 by approximately one-half of an inch. This bin configuration in the flattened position allows for easy storage. The stacking of bins on a shelf is easy and safe, and the flattened bin can even hang on a wall or suspended from a hanger for easy spray cleaning or scrubbing.

Alternatively, any multiple number of the cable 55 could be employed to flexibly connect the multiple of staves 25 of the bin 10. Also, as an alternative, a single cable could be employed instead of the preferred upper cable 56 and lower cable 57, or three or more cables could be employed, with a middle cable or a multiple of middle cables placed between the upper cable and the lower cable. With the single cable alternative, a flat, braided stainless steel cable is preferred, and the cable eye 60 for this single cable alternative matching the cross section of the single cable as a slot shape, rather than a circular hole for a twisted cable. This flat or ribbon type of cable also helps serve to prevent any stave 26 from twisting or rotating independently of other staves.

In use with the operation of the cider press 12, the cable 55 and bin is durable and reliable. Preferably, the cable, when a twisted strand stainless steel type of cable is employed, has a diameter of approximately 3/16th of an inch, which corresponds to having a working load rating of approximately 700 lbs of holding force. With the two cables, as preferred for use with the bin 10, the combined holding capacity is approximately 1,400 lbs. Preferably, each cable has a cable end 81 at the first terminal stave 66 and the second terminal stave, and each cable end has a stop 82, as shown in FIG. 4. Each stop is most preferably a crimped button type of stop. Crimped button types of stops are well known to those skilled in cable end terminators. Each crimped button stop is rated to hold approximately 50% of the cable strength, which is far less than the force employed in the press stage 19 of the cider press, to squeeze the cider from the mash 16.

The improved bin 10 of the present invention solves problems that all traditional bins exhibit. As discussed above, traditional bins used in apple pressing are fixed and ridged cylinders. When stored, the traditional bin requires a considerable volume. For instance, a typical twelve inch in diameter bin cylinder that is fourteen inches tall has an approximate volume of approximately 1,600 cubic inches, while the bin of the present invention, when in the flattened position 80, takes up only approximately 520 cubic inches.

Cleanup is very easy with the bin 10 of the present invention. After unhooking the bin latch 70 and un-rolling the multiple of staves 25, from the tubular formation 65, the bin can be cleaned by spraying between each stave 26, and easily dunked in a water trough and sterilized for safe use. Traditional fixed bins are difficult to clean. Spraying the traditional bins from the inside out is a very wet and a potentially unsanitary task, and often results in the undesirable scattering of apple material. The bin of the present invention solves the shared problems all other traditional, fixed basket bins share; their excessive required storage and difficult cleanup.

The terms “approximately,” and “proximate to,” are used herein to refer to a range of values or a range of relative orientations, understood by a person skilled in the pertinent field or skill, as being substantially equivalent or near to the herein stated values or positions in achieving the desired results, in a range typical to the accuracy and precision of conventional tooling, instrumentation or techniques, or a functionally equivalent range of features that produces equivalent results to those described herein.

Having now described the invention, to those skilled in the art to which it pertains, it may become apparent that the need to make modifications without deviating from the intention of the design as defined by the appended claims.

What is claimed is:

1. A bin for a cider press comprising:
the bin including a multiple of staves interconnected by a cable, the multiple of staves held together by the cable, and the cable threaded through a cable eye in each stave of the multiple of staves;
the multiple of staves including a first terminal stave, a multiple of middle staves and a second terminal stave;
the cable having a first cable end and a second cable end, the cable attached to the first terminal stave at a first stop that receives the first cable end, the cable threaded through the multiple of middle staves in series, and the second cable end attached to the second terminal stave at a second cable stop;
the cable maintains a separation of the multiple of staves, with the cable between each stave remaining bendable to form a cylindrical shape, and the multiple of staves positionable, so that the first terminal stave contacts the second terminal stave; and
a bin latch to lock the first terminal stave to the second terminal stave.

2. The bin of claim 1, wherein:
the cable comprises an upper cable and a lower cable, the upper cable and lower cable interconnect together the multiple of staves, the upper cable threaded through an upper cable eye in each stave of the multiple of staves, and the lower cable threaded through an lower cable eye in each stave of the multiple of staves;
the first cable end of the upper cable attached to the first terminal stave at an upper first stop, the upper cable threaded through the upper cable eye in each of the multiple of middle staves in series, and the second cable end of the upper cable attached to the second terminal stave at an upper second cable stop;
the first cable end of the lower cable attached to the first terminal stave at an lower first stop, the lower cable threaded through the lower cable eye in each of the multiple of middle staves in series, and the second cable end of the lower cable attached to the second terminal stave at an lower second cable stop;

3. The bin of claim 1, wherein the bin latch includes a stave hook in the first terminal stave that is received by and locks into a stave slot in the second terminal stave.

4. The bin of claim 3, wherein the stave hook is a set of stave hooks and the stave slot is a set of stave slots, with each of the set of stave hooks in the first terminal stave received by and locks into each of the set of stave slots in the second terminal stave.

5. The bin of claim 1, wherein the bin latch includes a stave slot in the first terminal stave that is received by and locks into a stave hook in the second terminal stave.

6. The bin of claim 5, wherein the stave slot is a set of stave slots and the stave hook is a set of stave hooks, each of the set of stave slots in the first terminal stave is receives and locks onto each of the set of stave hooks in the second terminal stave.

7. The bin of claim 1, wherein the cable is a flat ribbon in form, and the cable eye has a slot shape, and the cable prevent any stave of the multiple of staves from twisting or rotating independently of other staves of the multiple of staves, while still allowing the multiple of staves to form a cylindrical shape when the first terminal stave contacts the second terminal stave.
